(19) United States
(12) Patent Application Publication
(10) Pub. No.: US 2014/0062453 A1
(43) Pub. Date: Mar. 6, 2014

(54) POWER CONTROL METHOD AND APPARATUS

(71) Applicant: Samsung Electronics Co., Ltd., Gyeonggi-do (KR)

(72) Inventor: Han-Shil CHOI, Seoul (KR)

(73) Assignee: Samsung Electronics Co., Ltd., Gyeonggi-do (KR)

(21) Appl. No.: 14/012,034

(22) Filed: Aug. 28, 2013

(30) Foreign Application Priority Data
Aug. 28, 2012 (KR) 10-2012-0094265

(51) Int. Cl. G05F 5/00

(52) U.S. Cl. CPC G05F 5/00
USPC 323/318

(57) ABSTRACT

A power control method includes: detecting a first value of power required for a terminal; detecting a second value of power supplied from a power supply device; comparing the first value with the second value; and controlling power supplied from the power supply device to the terminal according to a result of the comparison.

### CLAIM OF PRIORITY

This application claims priority under 35 U.S.C. §119 to an earlier application filed in the Korean Intellectual Property Office on Aug. 28, 2012 and assigned Serial No. 10-2012-0094265, the contents of which are incorporated herein by reference.

### BACKGROUND

1. Field of the Invention

The present disclosure relates generally to a power control method and apparatus, and in particular, to a power control method and apparatus which control the power supplied from a power supply device to a portable terminal.

2. Description of the Related Art

Portable terminals, such as a mobile communication terminal (a cellular phone), an electronic notebook, and a personal digital assistant (PDA) have become necessary articles of modern life of transmitting information which changes rapidly.

Generally, mobile terminals are held by a user's hand during their use, or may put the mobile terminal on a flat surface or mount it on a stand device. In the case where the stand device is used, the user has the advantage of being able to operate the mobile terminal while comfortably facing the screen. Such a stand device not only mounts the portable terminal but also provides a charging function. That is, the stand device is electrically connected to a power supply device and transmits power supplied from power supply device to the portable terminal mounted thereon.

Recently, portable terminals are classified into a low-voltage type and a high-voltage type. As a result stand devices and power supply devices are further classified into a low-voltage type and a high-voltage type. Accordingly, a stand device and a power supply device are determined depending on whether the portable terminal is a low-voltage type or a high-voltage type. Therefore, the stand device and the power supply device cannot be used for all the portable terminals as some terminals require different driving voltages.

### SUMMARY

The present invention substantially solves at least the above problems and/or disadvantages and provides additional advantages, by providing a universal power control method and apparatus which are used to both a low-voltage portable terminal and a high-voltage portable terminal and capable of adjusting a charge power transmitted to the portable terminal according to the voltage type.

Another aspect of the present invention is to provide a power control apparatus which is electrically coupled to both a low-voltage power supply device and a high-voltage power supply device, and selectively adjusts power transmitted from the power supply device to a portable terminal according to a driving voltage of the portable terminal, and a power control method thereof

Another aspect of the present invention is to provide a power control method and apparatus which compare the driving power value of a portable terminal with the supply power value of a power supply device, and then selectively adjust power transmitted from the power supply device to the portable terminal.

Another aspect of the present invention is to provide a stand device for mounting a low-voltage portable terminal and a high-voltage portable terminal in common.

According to a first aspect of the present invention, a power control method, includes: detecting a first value of power required for a terminal; detecting a second value of power supplied from a power supply device; comparing the first value with the second value; and adjusting power supplied from the power supply device to the terminal according to a result of the comparison.

According to a second aspect of the present invention, a power control apparatus includes: a terminal interface unit electrically connected to a terminal to transmit power to the terminal; a power supply device interface unit electrically connected to a power supply device to receive power from the power supply device; a detection unit for detecting a first value of power required for the terminal from the terminal interface unit and a second value of power supplied from the power supply device; a comparison unit for comparing the first value with second value detected by the detection unit; an adjustment unit for reducing the power supplied from the power supply device interface unit from the second value to the first value and transmitting the reduced power to the terminal interface unit; a switch unit for electrically connecting the terminal interface unit to the power supply device interface unit or the power supply device interface unit to the adjustment unit under the control of a control unit; and the control unit for controlling the switch unit according to a comparison result obtained from the comparison unit.

According to a third aspect of the present invention, a power control apparatus includes: a unit for detecting a first value of power required for a terminal from the terminal interface unit and a second value of power supplied from a power supply device; and a unit for adjusting power supplied from the power supply device to the terminal according to a result of comparison of the first value and the second value.

According to another aspect of the present invention, a method in an electronic device comprises obtaining a power required for a terminal connected to the electronic device, obtaining a power supplied from a power supply device connected to the electronic device, and adjusting the power supplied from the power supply device to the power required for the terminal wherein the adjusting is reducing the power supplied from the power supply device when the power supplied from the power supply device is larger than the power required for the terminal

According to still another aspect of the present invention, a method in an electronic device comprises obtaining a power required for a terminal connected to the electronic device, obtaining a power supplied from a power supply device connected to the electronic device, and adjusting the power supplied from the power supply device to the power required for the terminal wherein the adjusting is amplifying the power supplied from the power supply device when the power required for the terminal is larger than the power supplied from the power supply device.

### BRIEF DESCRIPTION OF THE DRAWINGS

The above features and advantages of the present invention will become more apparent from the following detailed description when taken in conjunction with the accompanying drawings in which:

FIG. 1 is a diagram illustrating a stand device according to an exemplary embodiment of the present invention and a portable terminal mounted thereon;

FIG. 2 is a diagram illustrating a stand device according to an exemplary embodiment of the present invention;

FIG. 3 is a diagram illustrating a block configuration of a stand device according to an exemplary embodiment of the present invention; and

FIG. 4 is a flowchart illustrating a power control process according to an exemplary embodiment of the present invention.

### DETAILED DESCRIPTION

Exemplary embodiments of the present invention will be described herein below with reference to the accompanying drawings. For the purposes of clarity and simplicity, detailed descriptions of well-known functions or configurations will be omitted as they would unnecessarily obscure the subject matters of the present invention. Also, the terms used herein are defined according to the functions of the present invention. Thus, the terms may vary depending on users' or operators' intentions or practices. Therefore, the terms used herein should be understood based on the descriptions made herein.

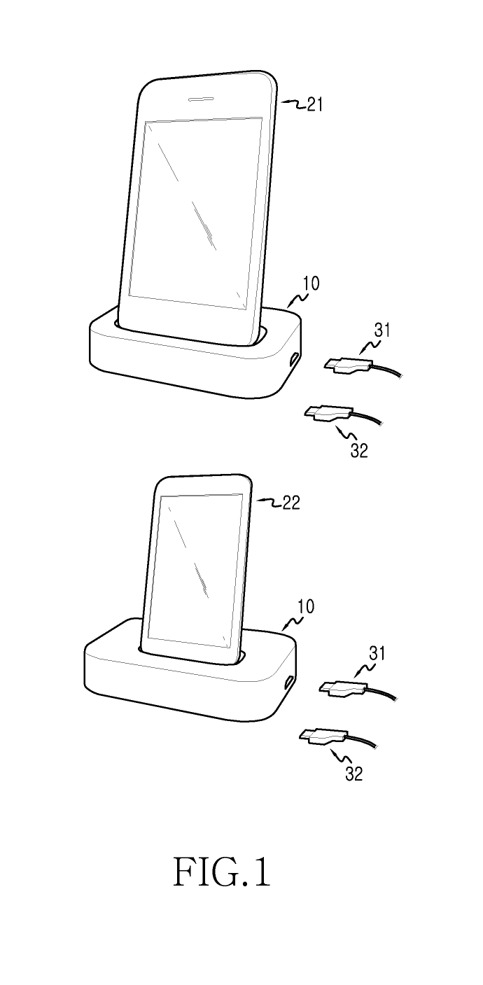

FIG. 1 is a diagram illustrating a stand device according to an exemplary embodiment of the present invention and a portable terminal mounted thereon.

Referring to FIG. 1, the stand device 10 is configured to mount a low-voltage portable terminal 21 or a high-voltage portable terminal 22 at a predetermined angle. The external appearances and sizes of the low-voltage portable terminal 21 and high-voltage portable terminal 22 may be different from each other, thus, the shape of the stand device 10 according to the present invention may be modified to mount different terminals. Further, the portable terminals 21 and 22 may be one of electronic devices, each including a well-known speaker, a display, a microphone and several buttons.

The stand device 10 may be electrically connected to a low-voltage power supply device 31 and also a high-voltage power supply device 32. The stand device 10 includes a standardized female connector which enables the low-voltage power supply device 31 and the high-voltage power supply device 32 to be electrically connected thereto.

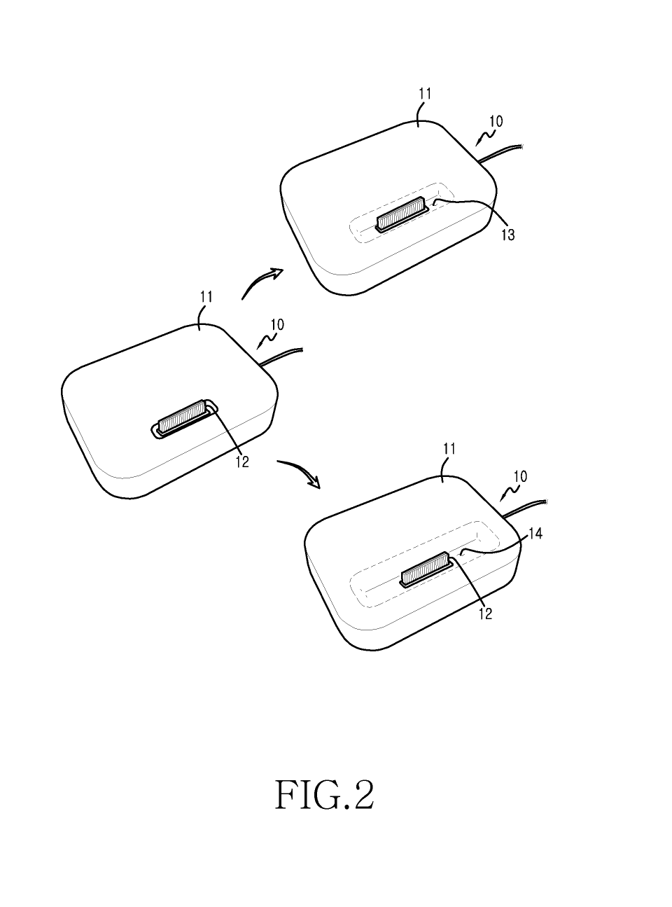

FIG. 2 is a diagram illustrating a stand device according to an exemplary embodiment of the present invention.

Referring to FIG. 2, the stand device 10 includes a housing 11 defining an external appearance, and a male connector 12 electrically connected to a circuit (not shown) placed within the housing 11 and protruded from the upper portion of the housing 11.

Each of the portable terminals 21 and 22 is equipped with a standardized female connector (not shown). When the portable terminal 21 or 22 is mounted on the stand device 10, the male connector 12 is electrically connected to the female connector.

The shape of the housing 11 forming the stand device 10 may be different to accommodate different sizes of the portable terminal 21 and 22. As shown, different shape 13 or 14 may be provided to receive different portable terminal 21 or 22 to be mounted thereon. Here, the housing 11 may be deformable to receive the terminal Known deformable material also may be used to form the stand device 10 for accommodating the portable terminal.

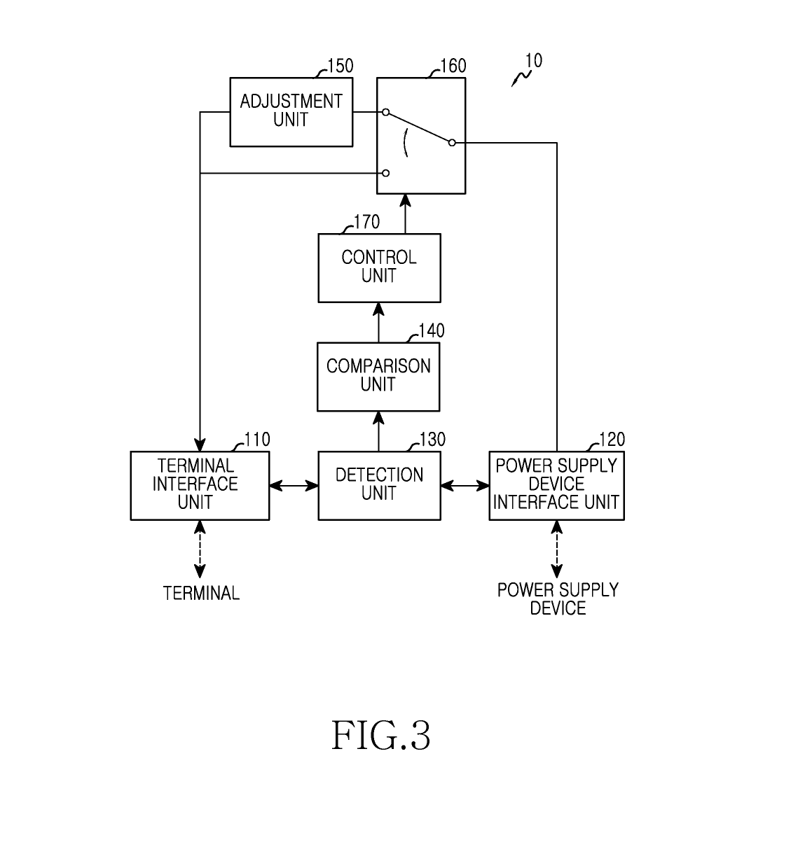

FIG. 3 is a diagram illustrating a block configuration of a stand device 10 according to an exemplary embodiment of the present invention.

Referring to FIG. 3, the stand device 10 includes a terminal interface unit 110, a power supply device interface unit 120, a detection unit 130, a comparison unit 140, an adjustment unit 150, a switch unit 160, and a control unit 170.

The terminal interface unit 110 is electrically connected to a portable terminal via a male connector 12, and transmits power to the portable terminal.

The power supply device interface unit 120 is electrically connected to a power supply device and receives power from the power supply device.

The detection unit 130 detects a first value for power (operational power) required for the portable terminal through the terminal interface unit 110 electrically connected to the portable terminal In addition, the detection unit 130 detects a second value for power (supply power) supplied from the power supply device interface unit 120 electrically connected to the power supply device. The detection unit 130 may receive information about the first value indicative of the power required for the portable terminal from the portable terminal through the terminal interface unit 110. For example, the terminal interface unit 110 may be configured by pins which may be included the male connector 12 for transmitting and receiving information with respect to the portable terminal, and receive the information about the first value for the power required for the portable terminal through the pins from the portable terminal The information on the power required for the portable terminal may be included in the portable terminal and this information may be transferred from the portable terminal to the stand device 10 through the terminal interface unit 110. Also, the stand device 10 may identify the power required for portable terminal by identifying the type of the portable terminal based on the database including the information regarding the required power for the portable terminals. Also, the detection unit 130 may detect whether the power supply device connected to the power supply device interface unit 120 is the low-voltage power supply device 31 or the high-voltage power supply device 32 using an analog-digital converter which may be included in the detection unit 130. The analog-digital converter converts the supply voltage from the power supply device into a digital value and the converted digital value may indicate whether the power supply device is the low-voltage power supply device 31 or the high-voltage power supply device 32. Here, the first value and the second value may be in unit of electrical power.

The comparison unit 140 compares the first value with the second value, which are obtained from the detection unit 130.

The adjustment unit 150 reduces the power supplied from the power supply device interface unit 120 from the second value to the first value according to predetermined criteria and transmits the reduced power to the terminal interface unit 110. A detailed description of selectively adjusting the power will be described later with reference to FIG. 3.

The switch unit 160 electrically connects the terminal interface unit 110 to the power supply device interface unit 120 or the adjustment unit 150 to the power supply device interface unit 120, under the control of the control unit 170.

The control unit 170 controls the switch unit 160 according to a comparison outcome obtained from the comparison unit 140.

When the first value is smaller than the second value, the control unit 170 controls the switch unit 160 to electrically connect the adjustment unit 150 to the terminal interface unit 110. Therefore, the terminal interface unit 110 transmits power having the second value which is transmitted from the power supply device interface unit 120.

On the other hand, when the first value is equal to or larger than the second value, the control unit 170 controls the switch unit 160 to electrically connect the terminal interface unit 110 to the power supply device interface unit 120. Therefore, the power having the second value supplied from the power supply device interface unit 120 is adjusted to power having the first value through the adjustment unit 150, and the terminal interface unit 110 transmits the power having the first value.

Here, the control unit 170, the comparison unit 140 and the detection unit 130 may be merged into one processor.

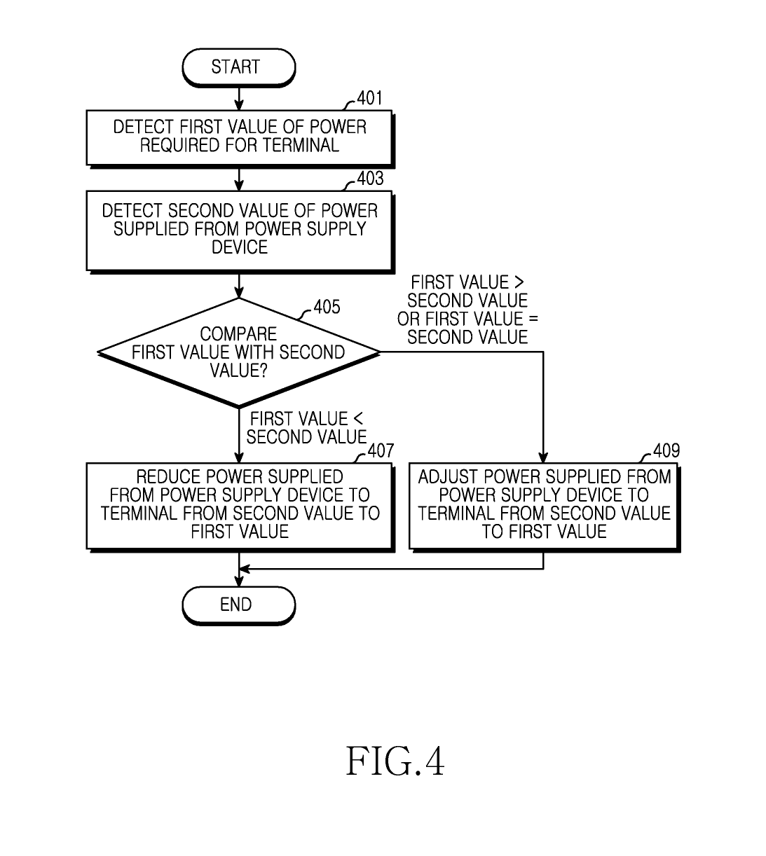

FIG. 4 is a flowchart illustrating a power control process according to an exemplary embodiment of the present invention.

Referring to FIG. 4, in step 401, the control unit 170 detects the first value of power required for a terminal. The detection method for obtaining the power required for the terminal described in connection with FIG. 3 may also be used.

In step 403, the control unit 170 detects the second value of power supplied from the power supply device. The detection method for obtaining the power supplied from the power supply device described in connection with FIG. 3 may also be used.

Here, the first value and the second value may be in unit of electrical power.

In step 405, the control unit 170 compares the detected first value with the detected second value.

When the first value is smaller than the second value in step 405, the control unit 170 proceeds to step 407. In step 407, the control unit 170 reduces the power supplied from the power supply device to the terminal from the second value to the first value.

On the other hand, when the first value is equal to or larger than the second, the control unit 170 proceeds to step 409. In step 409, the control unit 170 adjusts the power supplied from the power supply device to the terminal from the second value to the first value. Specifically, when the first value is equal to the second value, the control unit 170 passes the power supplied from the power supply device to the terminal by connecting the switch unit 160 to a path in which there is no adjustment unit 150. When the first value is larger than the second value, the control unit 170 connects the switch unit 160 to a path in which there is the adjustment unit 150. The adjustment unit 150 may include a power amplifier to amplify the supplied power to the power corresponding to the first value required for the portable terminal.

The methods according to the exemplary embodiments described in the claims and/or specification of the present invention may be implemented by hardware, software, or a combination thereof.

When the methods are implemented by software, a computer-readable storage medium may be provided to store one or more programs (software modules). The one or more programs stored in the computer-readable storage medium may be configured for execution by one or more processors in an electronic device. The one or more programs may include instructions for causing the electronic device to execute the methods according to the exemplary embodiments described in the claims and/or specification of the present invention.

These programs (software modules or software) may be stored in random access memories (RAMs), nonvolatile memories including flash memories, read only memories (ROMs), electrically erasable programmable ROMs (EEPROMs), magnetic disc storage devices, compact disc-ROMs (CD-ROMs), digital versatile discs (DVDs), other types of optical storage devices, or magnetic cassettes. Also, the programs may be stored in a memory configured by a combination of some or all of such storage devices. Also, each of the memories may be provided in plurality.

Accordingly, the power control method and apparatus according to the present invention adjust power supplied from a power supply device to be suitable for the operational power of a portable terminal and transmit the power to the portable terminal Therefore, the power control method and apparatus can be used in common to a plurality of portable terminals, thus resulting in reduction in resource waste and improvement in usability.

While the invention has been shown and described with reference to certain exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A power control method in an electronic device comprising:
detecting a first value of power required for a terminal;
detecting a second value of power supplied from a power supply device;
comparing the first value with the second value; and
adjusting power supplied from the power supply device to the terminal according to a comparison outcome.

2. The power control method of claim 1, wherein detecting the first value of power required for the terminal comprises:
receiving information about the first value of the power from the terminal through a pin included in a male connector.

3. The power control method of claim 1, wherein adjusting the power supplied from the power supply device to the terminal according to the comparison outcome comprises:
reducing the power supplied from the power supply device to the terminal from the second value to the first value when the first value is smaller than the second value.

4. The power control method of claim 1, wherein adjusting the power supplied from the power supply device to the terminal according to the comparison outcome comprises:
adjusting the power to be delivered from the power supply device to the terminal to the first value when the first value is larger than the second value.

5. A power control apparatus comprising:
a terminal interface unit electrically coupled to a terminal to transmit power to the terminal;
a power supply device interface unit electrically coupled to a power supply device to receive power from the power supply device;
a detection unit for detecting a first value of power required for the terminal from the terminal interface unit and a second value of power supplied from the power supply device;
a comparison unit for comparing the first value with the second value detected by the detection unit;
an adjustment unit for reducing the power supplied from the power supply device interface unit from the second value to the first value and transmitting the reduced power to the terminal interface unit;
a switch unit for electrically connecting the terminal interface unit to the power supply device interface unit or the power supply device interface unit to the adjustment unit under the control of a control unit; and
the control unit for controlling the switch unit according to a comparison outcome obtained from the comparison unit.

6. The power control apparatus of claim 5, wherein the detection unit receives information about the first value of the power from the terminal through the terminal interface unit.

7. The power control apparatus of claim 5, wherein the control unit controls the switch unit to electrically connect the adjustment unit to the terminal interface unit when the first value is smaller than the second value.

8. The power control apparatus of claim 5, wherein the control unit controls the switch unit to electrically connect the terminal interface unit to the power supply device interface unit when the first value is equal to or larger than the second value.

9. The power control apparatus of claim 5, further comprising:
a housing forming an external appearance,
wherein the housing is deformable to receive the terminal

10. A power control apparatus comprising:
a unit for detecting a first value of power required for a terminal from the terminal interface unit and a second value of power supplied from a power supply device; and
a unit for adjusting power supplied from the power supply device to the terminal according to a comparison outcome of the first value and the second value.

11. The power control apparatus of claim 10, wherein the power supplied from the power supply device to the terminal is adjusted from the second value to the first value when the first value is smaller than the second value.

12. The power control apparatus of claim 10, wherein the power supplied from the power supply device to the terminal is adjusted to the second value when the first value is equal to or larger than the second value.

13. A method in an electronic device comprising:
obtaining a power required for a terminal connected to the electronic device ;
obtaining a power supplied from a power supply device connected to the electronic device; and
adjusting the power supplied from the power supply device to the power required for the terminal,
wherein the adjusting is reducing the power supplied from the power supply device when the power supplied from the power supply device is larger than the power required for the terminal

14. The method of claim 13, wherein the obtaining the power required for the terminal comprises:
receiving information for the power from the terminal through a pin included in a male connector.

15. The method of claim 13, wherein obtaining the power supplied from the power supply device is performed by using an analog to digital converter.

16. A method in an electronic device comprising:
obtaining a power required for a terminal connected to the electronic device;
obtaining a power supplied from a power supply device connected to the electronic device; and
adjusting the power supplied from the power supply device to the power required for the terminal,
wherein the adjusting is amplifying the power supplied from the power supply device when the power required for the terminal is larger than the power supplied from the power supply device.

17. The method of claim 16, wherein the obtaining the power required for the terminal comprises:
receiving information for the power from the terminal through a pin included in a male connector.

18. The method of claim 16, wherein obtaining the power supplied from the power supply device is performed by using an analog to digital converter.
